(19) United States
(12) Patent Application Publication
(10) Pub. No.: US 2017/0005909 A1
(43) Pub. Date: Jan. 5, 2017

(54) WIRELESS UNDERGROUND COMMUNICATION SYSTEM

(71) Applicant: LINEAREDGE TECHNOLOGIES, LLC, Orem, UT (US)

(72) Inventors: Gregory L. Hunt, Cedaredge, CO (US); Mark Lund, Orem, UT (US); James Liin, Price, UT (US); Chris Poulsen, Orem, UT (US); Darryl Stewart, Orem, UT (US)

(21) Appl. No.: 15/201,251

(22) Filed: Jul. 1, 2016

Related U.S. Application Data
(60) Provisional application No. 62/187,738, filed on Jul. 1, 2015.

(51) Int. Cl. H04L 12/721; H04L 12/26; H04B 7/04; H04W 52/28; H04L 29/12; H04L 29/08; H04W 4/02

(52) U.S. Cl. CPC H04L 45/06; H04L 69/325; H04L 43/16; H04W 4/02; H04W 52/283; H04L 61/2007; H04B 7/0413; H04W 84/12

(57) ABSTRACT

Technology for a wireless underground communication system is disclosed. The wireless underground communication system can include a multi radio directional router (MRDR). The MRDR can include a dedicated in-by transceiver Wi-Fi node, and the dedicated in-by transceiver Wi-Fi node can be assigned a first unique IP address. The MRDR can include a dedicated out-by transceiver Wi-Fi node, and the dedicated out-by transceiver Wi-Fi node can be assigned a second unique IP address. The wireless underground communication system can include a routing module configured to route data between a plurality of MRDRs based on one or more of Optimized Link State Routing (OLSR) or Open Shortest Path First (OSPF), using the dedicated in-by transceiver Wi-Fi node and the dedicated out-by transceiver Wi-Fi node.

### RELATED APPLICATIONS

The present application claims priority to U.S. Provisional Patent Application No. 62/187,738, filed Jul. 1, 2015 with a docket number of 3946-002.PROV, the entire specification of which is hereby incorporated by reference in its entirety for all purposes.

### TECHNICAL FIELD

This disclosure relates to wireless communication systems for underground applications.

### BACKGROUND

The increased demand for wireless communication services has motivated significant evolution in wireless technology such as 3GPP LTE, WiMAX and several versions of Institute for Electrical and Electronic Engineers (IEEE) 802.11. However the evolution of wireless communication services has been limited to above ground applications. In other words, the wireless communication systems that have been designed for above ground, have not worked with the same degree of accuracy or speed when placed below ground. Furthermore, the need for wireless communication services has evolved to include tracking users and objects in underground environments, including mining. Specifically related to mining, the ability to track mine employees is of significant interest in promoting mining communication and safety. Systems that have been developed for wireless underground communication suffer from transmission delays, low throughput and latency issues. With such demand for wireless communication services and positioning services coupled with developments in wireless routing protocols, it is of interest to enhance the wireless communication and positioning service capabilities in underground environments which can deliver high data throughput and low latency, thereby ensuring ubiquitous access to wireless communication systems and location services from any location, in any environment or application, with any device and technology.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a block diagram of a wireless underground communication system in accordance with an example;

FIG. 2A illustrates a block diagram of communication between multiple adjacent multi radio directional routers (MRDRs) in accordance with an example;

FIG. 2B illustrates a block diagram of communication between adjacent MRDRs and a user device in accordance with an example;

FIG. 2C illustrates communication between dedicated Wi-Fi nodes used for in-by and out-by communications in accordance with an example;

FIG. 3A illustrates a block diagram of data being transmitted from one MRDR to another MRDR using the shortest of multiple possible paths in accordance with an example;

FIG. 3B illustrates a block diagram of data being transmitted from one MRDR to another MRDR using an alternative path in accordance with an example;

FIG. 4 illustrates a block diagram of an IP address assignment among multiple MRDRs in accordance with an example;

FIG. 5A illustrates a block diagram of a connection protocol between a user device and a MRDR in accordance with an example;

FIG. 5B illustrates a block diagram of a connection handoff protocol between a user device and multiple MRDRs in accordance with an example;

FIG. 6 illustrates a block diagram of data being transferred from one bidirectional array to another bidirectional array in accordance with an example;

FIG. 7 illustrates a diagram of tracking a user device based on communication between the user device and a dedicated WLAN Wi-Fi node of a MRDR in accordance with an example;

FIG. 8 illustrates a diagram of tracking a user device based on communication between multiple dedicated Wi-Fi nodes of a MRDR and a user device in accordance with an example;

FIG. 9 illustrates a diagram of tracking a user device based on communication between multiple directional antennas of dedicated Wi-Fi nodes of a MRDR and a user device in accordance with an example;

FIG. 10 depicts a flow chart of at least one non-transitory machine readable storage medium having instructions embodied thereon for operating a wireless underground communication system in accordance with an example;

FIG. 11 illustrates a diagram of a wireless user device in accordance with an example;

FIG. 12A illustrates an exemplary dedicated role assignment among multiple MRDRs in a master-client relationship in accordance with an example;

FIG. 12B illustrates an exemplary role assignment for specific communication transmission and reception among multiple MRDRs in a master-client relationship in accordance with an example;

FIG. 13 illustrates a MRDR mounting bracket that can be configured to couple a MRDR to a mine back or mine roof in accordance with an example;

FIG. 14A illustrates a diagram of a MRDR mounting bracket coupled to the back (roof) or rib and a MRDR suspended on the hangers of the MRDR mounting bracket during installation in accordance with an example;

FIG. 14B illustrates a diagram of a MRDR in a final position on a MRDR mounting bracket in accordance with an example;

FIG. 15 illustrates a block diagram of a power supply/battery backup (PSBB) that can be configured to power the MRDR in accordance with an example;

FIG. 16 illustrates a PSBB mounting bracket that can be configured to couple a PSBB to a mine back or mine roof in accordance with an example; and

FIG. 17 illustrates a diagram of multiple PSBBs coupled together with AC feed trunk power lines and lateral power lines.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

A technology is described for a wireless underground communication system. A network of multi radio directional routers (MRDRs) can be placed throughout an underground environment. Each MRDR can include multiple radios or Wi-Fi nodes, where each Wi-Fi node can be a dedicated Wi-Fi node for a particular function. Each dedicated Wi-Fi node can be assigned a unique IP address. This unique IP address for each dedicated Wi-Fi node can allow each dedicated Wi-Fi node to perform a designated role, independent from the other dedicated Wi-Fi nodes of a MRDR. In other words, the wireless network can be fully routed because each dedicated Wi-Fi node can have its own unique IP address.

In one embodiment, each MRDR can include three or more dedicated Wi-Fi nodes. One dedicated Wi-Fi node can be designated as a dedicated in-by transceiver Wi-Fi node. One dedicated Wi-Fi node can be designated as a dedicated out-by transceiver Wi-Fi node. One dedicated node can be designated as a wireless local area network (WLAN) node or a dedicated WLAN Wi-Fi node. A routing module coupled to the three or more dedicated Wi-Fi nodes can be configured to direct data between multiple MRDRs based on a routing format or protocol. In one example, the routing protocol can be Optimized Link State Routing (OLSR) or Open Shortest Path First (OSPF). However, this is not intended to be limiting. Other types of routing protocols can also be used.

In another embodiment, each dedicated Wi-Fi node can be dedicated for specific communication transmission and reception. In one example, a dedicated Wi-Fi node can be connected to an antenna. The antenna can be oriented relative to a specific direction within an underground complex such as a mine or cave. Inby communications can be communications directed into a mine or underground complex and out-by communications can be communications directed out of the mine or underground complex. The antenna can be oriented into or oriented out of the mine or underground complex. A dedicated Wi-Fi node connected to the antenna can be dedicated to transmitting in-by communications and receiving out-by communications. In other words, when data is being sent into the mine (i.e. in-by communications), a dedicated Wi-Fi node connected to an antenna oriented for in-by communications can be a dedicated out-by transceiver Wi-Fi node to transmit data to an adjacent MRDR further into the mine. When data is being sent out of the mine (i.e. out-by communications), the dedicated Wi-Fi node can be a dedicated in-by transceiver Wi-Fi node to receive data coming out of the mine.

In one embodiment, a dedicated Wi-Fi node of a MRDR can form a master-client relationship with a dedicated Wi-Fi node of an adjacent MRDR. The dedicated Wi-Fi node at the MRDR can be designated as a master and the dedicated Wi-Fi node of the adjacent MRDR can be designated as a client. In another configuration, each dedicated Wi-Fi node in the master-client relationship can be configured as a dedicated in-by transceiver Wi-Fi node, a dedicated out-by transceiver Wi-Fi node, a dedicated WLAN Wi-Fi node, or a dedicated crosscut Wi-Fi node. In another configuration, each dedicated Wi-Fi node in the master-client relationship can be dedicated for a specific communication transmission and reception, such as in-by and out-by communication. Each dedicated Wi-Fi node in the master-client relationship can be preconfigured as either a master Wi-Fi node configured to communicate with a client Wi-Fi node, or vice versa. A fully routed network with multiple nodes and a routing protocol can reduce latency by lower delays within a router. For example, data can be received by a single transceiver node in a wireless underground communication system. The single transceiver node can require time to receive the signal, compute the next location and transmit the signal, all on the same hardware. The time delay between receiving, processing, and transmitting the signal with one piece of hardware can cause latency issues. Further, less data processed at one time can decrease the throughput of a wireless underground communication system. The present technology can use multiple dedicated Wi-Fi nodes to resolve latency issues and increase data throughput.

For example, data can be received by the dedicated in-by transceiver Wi-Fi node of a MRDR. A routing module can route data to the dedicated out-by transceiver Wi-Fi node of the MRDR. From the dedicated out-by transceiver Wi-Fi node of the MRDR, the data can be transmitted and received by a dedicated in-by transceiver Wi-Fi node of an adjacent MRDR. The adjacent MRDR can be chosen based on the most efficient path as determined by the routing module in the MRDR. This data transfer can start from any MRDR and can continue to a wireless underground communication server or hub, or any other destination within the wireless network, including other MRDRs.

The wireless underground communication system can also be used for tracking and locating users and objects. The dedicated in-by transceiver Wi-Fi node, the dedicated out-by transceiver Wi-Fi node, and the dedicated WLAN Wi-Fi node can be used for tracking a location tag receiver, which can include a user device, such as a wireless phone, a tablet, or a wireless transceiver used to track location. Each dedicated Wi-Fi node can receive a location signal for a user device. The received location signal can have a power level at which it is received by a respective dedicated Wi-Fi node. The IP address of each dedicated Wi-Fi node, the location signals and the power levels at which the location signals were received at by each dedicated Wi-Fi node can be transmitted to a location server. Additionally, a user device can receive a location signal from a dedicated Wi-Fi node and transmit the location signal to a location server. The location server can associate the IP address of each dedicated Wi-Fi node with a location perimeter of each dedicated Wi-Fi node based on a predetermined geographic location. The location server can determine a location of the user device within a common sub-perimeter of each location perimeter based on the power level at which the location signal was received by each dedicated Wi-Fi node.

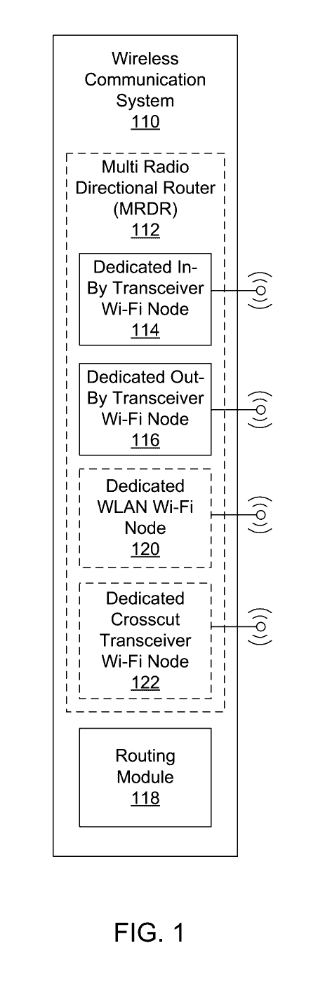

FIG. 1 illustrates an example wireless underground communication system 110. The wireless underground communication system can have a multi radio directional router (MRDR) 112 and a routing module 118. The MRDR can include a dedicated in-by transceiver Wi-Fi node 114 and a dedicated out-by transceiver Wi-Fi node 116. The dedicated in-by transceiver Wi-Fi node 114 can be configured to communicate using at least one wireless communication standard including the third generation partnership project (3GPP) long term evolution (LTE) Release 8, 9, 10, 11, or 12, Institute of Electronics and Electrical Engineers (IEEE) 802.16.2-2004, IEEE 802.16k-2007, IEEE 802.16-2012, IEEE 802.16.1-2012, IEEE 802.16p-2012, IEEE 802.16.1 b-2012, IEEE 802.16n-2013, IEEE 802.16.1a-2013, WiMAX, High Speed Packet Access (HSPA), Bluetooth v4.0, Bluetooth Low Energy, Bluetooth v4.1, Bluetooth v4.2, IEEE 802.11a, IEEE 802.11b, IEEE 802.11g, IEEE 802.11n, IEEE 802.11 ac, or IEEE 802.11 ad, or another desired wireless communication standard.

The dedicated in-by transceiver Wi-Fi node 114 can be configured to communicate using an industrial, scientific and medical (ISM) radio band. For example, the Wi-Fi node may operate at a center frequency of one or more of 2.4 GHz, 3.6 GHz, 4.9 GHz, 5 GHz, or 5.9 GHz, or another desired ISM radio band. The dedicated in-by transceiver Wi-Fi node 114 can be assigned a first unique IP address. The dedicated in-by transceiver Wi-Fi node can be functionally dedicated to only receive data. The dedicated in-by transceiver Wi-Fi node can include one or more antennas. The one or more antennas can be configured to operate using multiple input multiple output (MIMO).

The dedicated out-by transceiver Wi-Fi node 116 can be configured to communicate using at least one wireless communication standard including the third generation partnership project (3GPP) long term evolution (LTE) Release 8, 9, 10, 11, or 12, Institute of Electronics and Electrical Engineers (IEEE) 802.16.2-2004, IEEE 802.16k-2007, IEEE 802.16-2012, IEEE 802.16.1-2012, IEEE 802.16p-2012, IEEE 802.16.1 b-2012, IEEE 802.16n-2013, IEEE 802.16.1a-2013, WiMAX, High Speed Packet Access (HSPA), Bluetooth v4.0, Bluetooth Low Energy, Bluetooth v4.1, Bluetooth v4.2, IEEE 802.11a, IEEE 802.11b, IEEE 802.11g, IEEE 802.11n, IEEE 802.11ac, or IEEE 802.11ad, or another desired wireless communication standard. The dedicated out-by transceiver Wi-Fi node 116 can be configured to communicate using the same frequencies as the dedicated in-by transceiver Wi-Fi node 114. The dedicated out-by transceiver Wi-Fi node 116 can be assigned a second unique IP address. The dedicated out-by transceiver Wi-Fi node 116 can be functionally designated to only transmit data. The dedicated out-by transceiver Wi-Fi node 116 can include one or more antennas. The one or more antennas of the dedicated out-by transceiver Wi-Fi node 116 can be configured to operate using multiple input multiple output (MIMO). The routing module 118 can be configured to route data between multiple MRDRs using the dedicated in-by transceiver Wi-Fi node 114 and the dedicated out-by transceiver Wi-Fi node 116.

In one example, the routing module 118 can route data between multiple MRDRs based on Optimized Link State Routing (OLSR) routing protocol using the dedicated in-by transceiver Wi-Fi node 114 and the dedicated out-by transceiver Wi-Fi node 116. The routing module 118 can use OLSR routing protocol to determine a fastest path or a shortest path between adjacent MRDRs, between a MRDR 112 and a server, or between a MRDR and a user device. In another example, the routing module 118 can route data between multiple MRDRs based on Open Shortest Path First (OSPF) routing protocol using the dedicated in-by transceiver Wi-Fi node 114 and the dedicated out-by transceiver Wi-Fi node 116. The routing module 118 can use OSPF routing protocol to determine a fastest path or a shortest path between adjacent MRDRs, between a MRDR 112 and a server, or between a MRDR and a user device.

In another configuration, the MRDR 112 can include a dedicated wireless local area network (WLAN) Wi-Fi node 120. The dedicated WLAN Wi-Fi node 120 can be configured to communicate using at least one wireless communication standard including the third generation partnership project (3GPP) long term evolution (LTE) Release 8, 9, 10, 11, or 12, Institute of Electronics and Electrical Engineers (IEEE) 802.16.2-2004, IEEE 802.16k-2007, IEEE 802.16-2012, IEEE 802.16.1-2012, IEEE 802.16p-2012, IEEE 802.16.1b-2012, IEEE 802.16n-2013, IEEE 802.16.1a-2013, WiMAX, High Speed Packet Access (HSPA), Bluetooth v4.0, Bluetooth Low Energy, Bluetooth v4.1, Bluetooth v4.2, IEEE 802.11a, IEEE 802.11b, IEEE 802.11g, IEEE 802.11n, IEEE 802.11ac, or IEEE 802.11ad, or another desired wireless communication standard. The dedicated WLAN Wi-Fi node 120 can be configured to communicate using the same frequencies as the dedicated in-by transceiver Wi-Fi node 114. The dedicated WLAN Wi-Fi node 120 can be assigned a third unique IP address. The dedicated WLAN Wi-Fi node 120 can be functionally designated to only communicate with user devices in a WLAN. The dedicated WLAN Wi-Fi node can include one or more antennas. The dedicated WLAN Wi-Fi node can be configured to operate using multiple input multiple output (MIMO).

In another configuration, the MRDR 112 can include one or more dedicated crosscut transceiver Wi-Fi nodes 122. The dedicated crosscut transceiver Wi-Fi node 122 can be configured to communicate using at least one wireless communication standard including the third generation partnership project (3GPP) long term evolution (LTE) Release 8, 9, 10, 11, or 12, Institute of Electronics and Electrical Engineers (IEEE) 802.16.2-2004, IEEE 802.16k-2007, IEEE 802.16-2012, IEEE 802.16.1-2012, IEEE 802.16p-2012, IEEE 802.16.1b-2012, IEEE 802.16n-2013, IEEE 802.16.1a-2013, WiMAX, High Speed Packet Access (HSPA), Bluetooth v4.0, Bluetooth Low Energy, Bluetooth v4.1, Bluetooth v4.2, IEEE 802.11a, IEEE 802.11b, IEEE 802.11g, IEEE 802.11n, IEEE 802.11ac, or IEEE 802.11ad, or another desired wireless communication standard. The dedicated crosscut transceiver Wi-Fi node 122 can be configured to communicate using the same frequencies as the dedicated in-by transceiver Wi-Fi node 114. Each dedicated crosscut transceiver Wi-Fi node 122 can be assigned a unique IP address. In one embodiment, an in-by transceiver Wi-Fi node can be assigned a first IP address, an out-by transceiver Wi-Fi node can be assigned a second IP address, a MRDR can have a dedicated wireless local area network (WLAN) Wi-Fi node assigned with a third unique IP address, a dedicated crosscut transceiver Wi-Fi node can have a fourth unique IP address, and a second dedicated crosscut transceiver node can be assigned a fifth unique IP address. The dedicated crosscut transceiver Wi-Fi node 122 can be functionally designated to only communicate with a dedicated crosscut transceiver Wi-Fi node 122 of an adjacent MRDR of an adjacent bidirectional MRDR array. The dedicated crosscut Wi-Fi node can include one or more antennas. The dedicated crosscut Wi-Fi node can be configured to operate using multiple input multiple output (MIMO). This feature will be discussed in more detail in paragraphs below.

The MRDR 112 can be configured to communicate with other MRDRs in a bidirectional array. Multiple MRDRs can be configured into a Layer 3 routing format. In other words, a MRDR 112 can be configured to receive data and to select the most efficient path the data can take based on the destination of the data. In addition, the MRDR can use the one or more dedicated crosscut transceiver Wi-Fi nodes 122 to communicate with MRDRs in other bidirectional arrays. One or more of the MRDRs can communicate data between the underground wireless communication system 112 and one or more of a local area network (LAN), a wireless local area network (WLAN), a wide area network (WAN), a wireless wide area network (WWAN), and the internet.

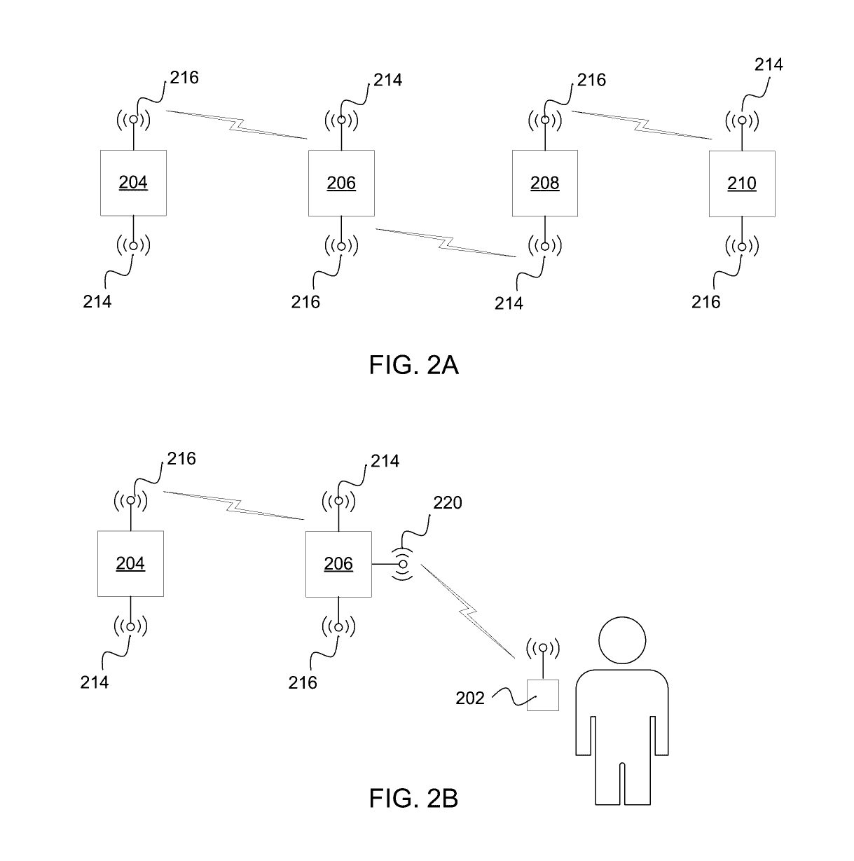

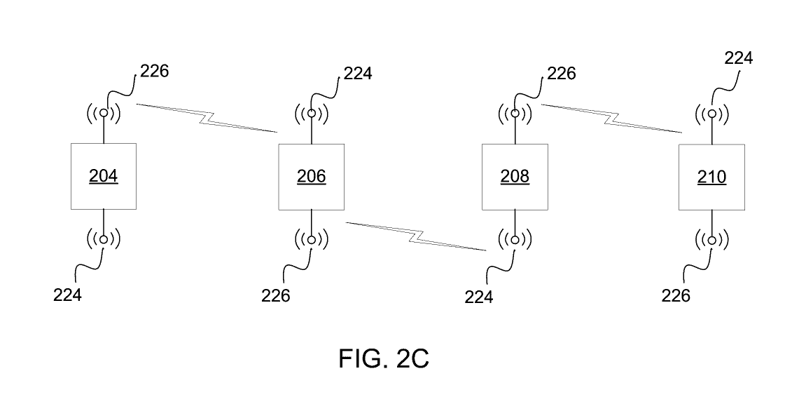

FIG. 2A illustrates communication between multiple adjacent MRDRs. In one configuration, multiple MRDRs can be placed in an underground environment to create the wireless underground communication system. MRDRs can be placed on wall edges, down shafts, in mine crosscut locations, or in any location where a MRDR can communicate with an adjacent MRDR. The spacing between MRDRs can be determined by the power level received between adjacent MRDRs. An example of an ideal power level or minimum signal strength between adjacent MRDRs is −80 dBm.

In one example, an MRDR 204 can transmit data to a different MRDR 210. The MRDR 204 can transmit the data from the dedicated out-by transceiver Wi-Fi node 216 to the dedicated in-by transceiver Wi-Fi node 214 of an adjacent MRDR 206. The data can then be routed from the dedicated in-by transceiver Wi-Fi node 214 of MRDR 206 to the dedicated out-by transceiver Wi-Fi node 216 of MRDR 206. The data can then be transmitted to the dedicated in-by transceiver Wi-Fi node 214 of an adjacent MRDR 208. The data can then be routed from the dedicated in-by transceiver Wi-Fi node 214 of MRDR 208 to the dedicated out-by transceiver Wi-Fi node 216 of MRDR 208. The data can then be transmitted to the dedicated in-by transceiver Wi-Fi node 214 of an adjacent MRDR 210, where the data can be stored.

While the example of FIG. 2A only includes transmission to an adjacent MRDR, this is not intended to be limiting. In one embodiment, MRDR 204 may transmit to MRDR 208 or 210, effectively skipping adjacent MRDRs when the signal strength between non-adjacent MRDRs is sufficient. Multiple MRDRs can be configured into a Layer 3 routing format. In other words, a MRDR 204 can be configured to receive data and to select the most efficient path the data can take based on the destination of the data, regardless of which MRDR is adjacent. A plurality of MRDRs may be positioned sufficiently close to allow communication between non-adjacent MRDRs. The location and spacing of MRDRs within an environment, such as an underground mine, can be based on the communication range of a dedicated wireless local area network (WLAN) Wi-Fi node with a user device. The use of directional antennas and MIMO can allow the dedicated out-by transceiver Wi-Fi node 216 and the dedicated in-by transceiver WiFi node 214 to communicate over a greater distance than a WLAN Wi-Fi node 220 that is configured to communicate over a wide area, such as 90 degrees, 180 degrees, 270 degrees, 360 degrees, or another desired range.

FIG. 2B illustrates communication between MRDRs and a user device. In one example, a MRDR 204 can transmit data with a destination of user device 202. The MRDR 204 can transmit the data from the dedicated out-by transceiver Wi-Fi node 216 to the dedicated in-by transceiver Wi-Fi node 214 of an adjacent MRDR 206, or a non-adjacent MRDR capable of communicating with the user device 202. The data can then be routed from the dedicated in-by transceiver Wi-Fi node 214 of a MRDR within communication range of the user device 202, such as MRDR 206, to the dedicated WLAN Wi-Fi node 220. The data can then be transmitted to the user device 202. In another example, the data can also be routed from the dedicated in-by transceiver Wi-Fi node 214 of MRDR 206 to the dedicated out-by transceiver Wi-Fi node 216 of MRDR 206.

FIG. 2C illustrates communication between dedicated Wi-Fi nodes dedicated for in-by and out-by communications. In this example, the dedicated Wi-Fi nodes are named based on the direction in which they transmit data. In one example, a MRDR 204 can be configured with a dedicated in-by Wi-Fi node dedicated for transmitting in-by communications and receiving out-by communications. For instance, a dedicated in-by Wi-Fi node 226 of the MRDR 204 can transmit data in-by to be received by the dedicated out-by Wi-Fi node 224 of an adjacent MRDR 206. The dedicated out-by Wi-Fi node 214 of MRDR 206 can be configured to transmit the data out-by to be received by the dedicated in-by Wi-Fi node 226 of the adjacent MRDR 204.

In one example, data can be transmitted into a mine or in-by. The dedicated in-by Wi-Fi node 226 can transmit data to the dedicated out-by Wi-Fi node 224 of an adjacent MRDR 206. The data can then be routed from the dedicated out-by Wi-Fi node 224 of MRDR 206 to the dedicated in-by Wi-Fi node 226 of MRDR 206. The data can then be transmitted to the dedicated out-by Wi-Fi node 224 of an adjacent MRDR 208. The data can then be routed from the dedicated out-by Wi-Fi node 224 of MRDR 208 to the dedicated in-by Wi-Fi node 226 of MRDR 208. The data can then be transmitted to the dedicated in-by transceiver Wi-Fi node 214 of an adjacent MRDR 210, where the data can be stored.

In other words, the dedicated in-by Wi-Fi node 226 of the MRDR 204 can be a dedicated out-by transceiver Wi-Fi node for in-by communications and can be a dedicated in-by transceiver Wi-Fi node for out-by communications. The dedicated out-by Wi-Fi node 224 of the adjacent MRDR 206 can be a dedicated in-by transceiver Wi-Fi node for in-by communications and can be a dedicated out-by transceiver Wi-Fi node for out-by communications.

In another example, data can be transmitted out of a mine or out-by. The data can be transmitted similarly to the previous example, except the dedicated out-by Wi-Fi nodes of each MRDR can transmit the data and the dedicated in-by Wi-Fi nodes of each MRDR can receive the data. Each MRDR 204, 206, 208, 210 can also include a dedicated WLAN Wi-Fi node 220 that can be configured to transmit and receive communications with a user device 202, as shown in FIG. 2B.

In another embodiment, the dedicated out-by Wi-Fi node 224 of a MRDR 204 and the dedicated in-by Wi-Fi node 226 of the adjacent MRDR 206 can enter a master-client relationship. In one configuration, the dedicated out-by Wi-Fi node 224 of the MRDR 204 can be pre-defined as the master in the master-client relationship with the dedicated in-by Wi-Fi node 226 of the adjacent MRDR 206, The dedicated in-by Wi-Fi node 226 of adjacent MRDR 206 can be predefined as the client in the master-client relationship with the dedicated out-by W-Fi node 224 of the MRDR 204.

In the example of FIG. 2C, each MRDR can include a dedicated out-by Wi-Fi node and a dedicated in-by Wi-Fi node. Each in-by node can include one or more antennas positioned for in-by transmission. The antenna(s) can be configured for MIMO communication with an adjacent dedicated out-by Wi-Fi node. The antenna(s) can also be for directional communication. Using the examples in the preceding paragraphs, MRDR 204 can include a dedicated in-by Wi-Fi node 226 for transmitting in-by communications and receiving out-by communications. The MRDR 204 can include a dedicated out-by Wi-Fi node 224 configured to transmit out-by communications and receive in-by communications. Each of the nodes 214 and 226 can be assigned different IP addresses than other nodes within the communication system. Similarly, MRDR 206 can include a dedicated out-by Wi-Fi node 224 configured to transmit out-by communications and receive in-by communications, and a dedicated in-by Wi-Fi node 216 configured to transmit in-by communications and receive out-by communications. Each MRDR 204, 206 can also include a dedicated WLAN Wi-Fi node 220 that can be configured to transmit and receive communications with a user device 202, as shown in FIG. 2B.

In another configuration, each dedicated Wi-Fi node in the master-client relationship can be dedicated as a dedicated in-by transceiver Wi-Fi node, a dedicated out-by transceiver Wi-Fi node, a dedicated WLAN Wi-Fi node, or a dedicated crosscut node. In another configuration, each dedicated Wi-Fi node in the master-client relationship can be used for specific communication transmission and reception, such as in-by and/or out-by communications.

In one example, the dedicated Wi-Fi node 224, as master in the master-client relationship, can be configured as a dedicated out-by transceiver Wi-Fi node for communications between the MRDR 204 and the adjacent MRDR 206. The dedicated Wi-Fi node 226, as client in the master-client relationship, can be configured as a dedicated in-by transceiver Wi-Fi node for communications between the MRDR 204 and the adjacent MRDR 206.

In another example, the dedicated Wi-Fi node 224, as master in the master-client relationship, can be a dedicated out-by Wi-Fi node for out-by communications and a dedicated in-by transceiver Wi-Fi node for in-by communications. The dedicated in-by Wi-Fi node 226, as client in the master-client relationship, can be a dedicated in-by transceiver Wi-Fi node for out-by communications and a dedicated out-by transceiver Wi-Fi node for in-by communications.

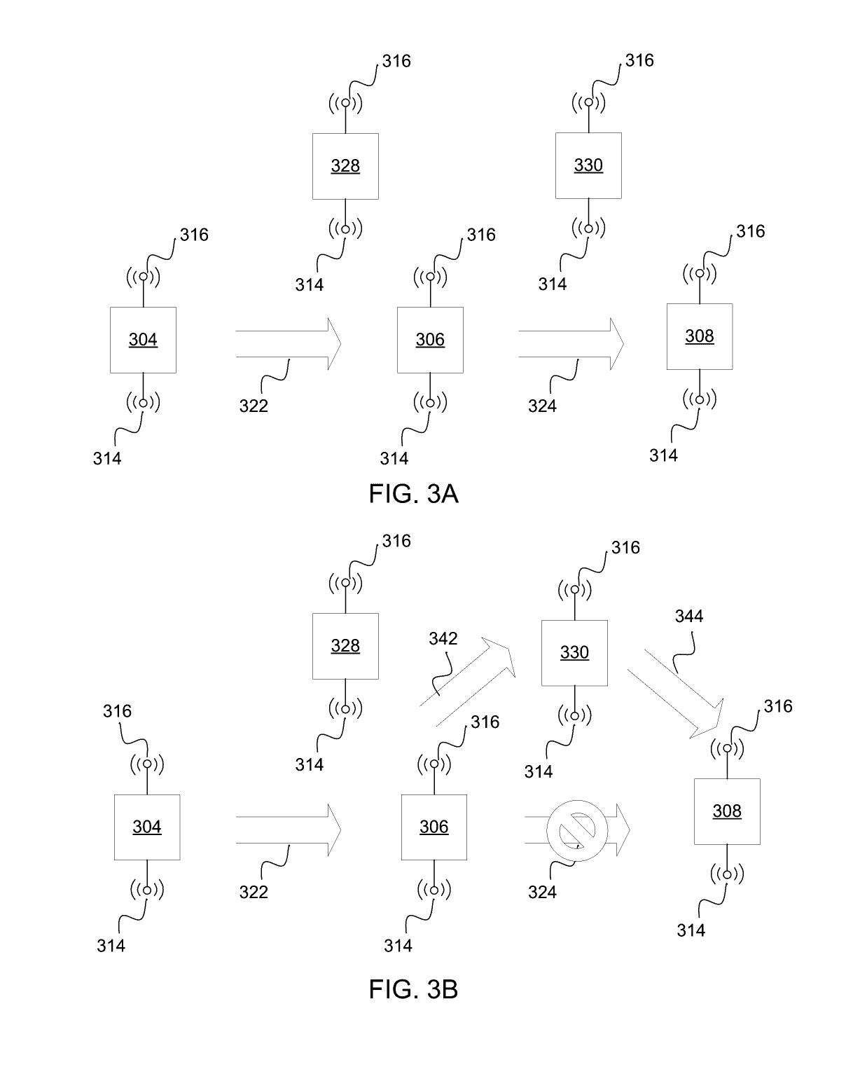

FIG. 3A illustrates exemplary communication between adjacent MRDRs using a routing format or protocol. A routing module (as shown in FIG. 1) can use a routing protocol to route data between Wi-Fi nodes located in multiple MRDRs. A MRDR 304 can receive data at a dedicated in-by transceiver Wi-Fi node 314. A routing module 118 can determine the destination of the data (in this example MRDR 308) and individually select a most efficient path 322 for the data. The routing module can route the data to the dedicated out-by transceiver Wi-Fi node 316 of MRDR 304 to transmit the data to an adjacent MRDR 306 on the selected most efficient path 322. Alternatively, depending on the spacing of the MRDRs, the most efficient path may be to transmit the data directly to MRDR 308. The dedicated in-by transceiver Wi-Fi node 314 can receive the data and a routing module can determine the destination of the data (in this example MRDR 308) and individually select a most efficient path 324 for the data. In this example, the data can be routed to the dedicated out-by transceiver Wi-Fi node 316 of the MRDR 306 to transmit the data to the destination along the most efficient path 324. The data can be received by the dedicated in-by transceiver Wi-Fi node 314 at MRDR 308.

While the example of FIG. 3A only includes transmission to an adjacent MRDR, this is not intended to be limiting. In one embodiment, MRDR 304 may transmit to MRDR 308, effectively skipping adjacent MRDRs when the signal strength between non-adjacent MRDRs is sufficient.

FIG. 3B illustrates another exemplary communication between adjacent MRDRs using a routing format or protocol. The routing module (as shown in FIG. 1) can use a routing protocol to route data between multiple MRDRs. A MRDR 304 can receive data at a dedicated in-by transceiver Wi-Fi node 314. A routing module 118 can determine the destination of the data (in this example, destination MRDR 328) and individually select a most efficient path 322 for the data. The routing module can route the data to the dedicated out-by transceiver Wi-Fi node 316 of the MRDR 304 to transmit the data to an adjacent MRDR 306 on the selected most efficient path 322. The dedicated in-by transceiver Wi-Fi node 314 can receive the data and a routing module can determine the destination of the data (in this example, destination MRDR 328) and individually select a most efficient path 324 for the data. However, the most efficient path 324 may not be accessible. Therefore, a most efficient path 342 can be selected by the routing module and the data can be routed to the dedicated out-by transceiver Wi-Fi node 316 of the MRDR 306. The dedicated in-by transceiver Wi-Fi node of adjacent MRDR 330 can receive the data and the routing module 118 can determine the destination of the data and select the most efficient path 344. The data can be routed to the dedicated out-by transceiver Wi-Fi node 316 of the MRDR 330 and then transmitted to the destination MRDR 328.

In one configuration, multiple MRDRs can be configured in a link state routing protocol such as Optimized Link State Routing or Open Shortest Path First.

In another configuration and referring also to FIG. 3A, multiple MRDRs can be configured into a Layer 3 routing format. In other words, a MRDR 304 can be configured to receive data and to select the most efficient path the data can take based on the destination of the data. The MRDR 304 can send the data to an adjacent MRDR 306 (or a non-adjacent MRDR) on a selected most efficient path, such as path 322 in this example. The adjacent MRDR 306 can be configured to receive the data and can likewise determine a most efficient path 324 based on the destination of the data.

Referring also to FIG. 3B, a Layer 3 routing format can allow the data to be dynamically routed down a different most efficient path 342 when a previously determined most efficient path 324 is no longer available or is no longer the most efficient path. Each most efficient path can be selected at a MRDR, regardless of what most efficient path was selected by a preceding MRDR. This is unlike layer 2 routing, where data cannot be rerouted in the middle of a communication if an error occurs along the most efficient path.

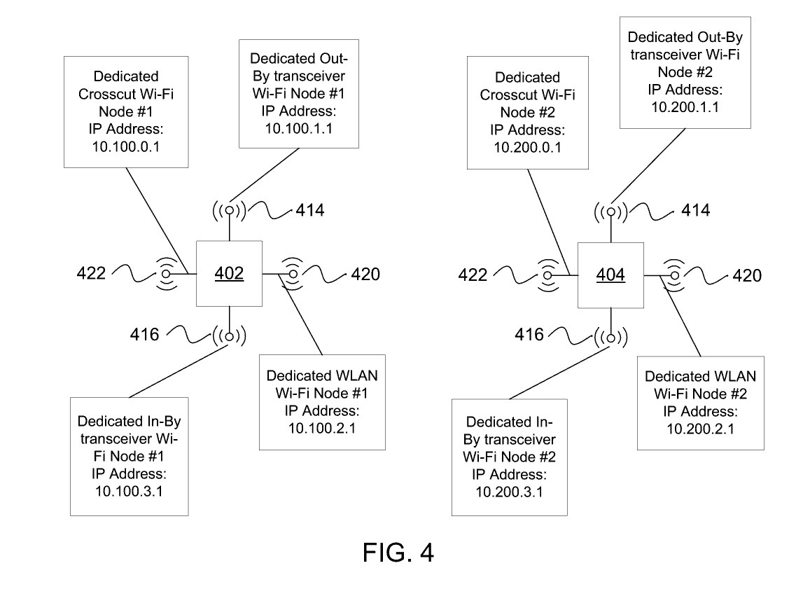

FIG. 4 illustrates an exemplary IP address assignment among multiple MRDRs. In this example, MRDR 402 includes four dedicated Wi-Fi nodes; a dedicated in-by transceiver Wi-Fi node 416, a dedicated out-by transceiver Wi-Fi node 414, a dedicated WLAN Wi-Fi node 420, and a dedicated crosscut transceiver Wi-Fi node 422. Additional dedicated crosscut Wi-Fi nodes may also be included, with each node assigned a unique IP address. The dedicated out-by transceiver Wi-Fi node 414 can be assigned an IP address of 10.100.1.1. The dedicated in-by transceiver Wi-Fi node 416 can be assigned an IP address of 10.100.3.1. The dedicated WLAN Wi-Fi node 420 can be assigned an IP address of 10.100.2.1. The dedicated crosscut transceiver Wi-Fi node 422 can be assigned an IP address of 10.100.4.1. An adjacent MRDR 404 can have four similar dedicated Wi-Fi nodes. The dedicated out-by transceiver Wi-Fi node 414 can be assigned an IP address of 10.200.1.1. The dedicated in-by transceiver Wi-Fi node 416 can be assigned an IP address of 10.200.3.1. The dedicated WLAN Wi-Fi node 420 can be assigned an IP address of 10.200.2.1. The dedicated crosscut transceiver Wi-Fi node 422 can be assigned an IP address of 10.200.4.1. A unique IP address for each dedicated Wi-Fi node in the network can allow the wireless underground communication system to exploit higher data throughput and reduce latency issues.

Referring also to FIG. 4, the IP address can be assigned based on information specific to the dedicated Wi-Fi node, such as a mine or underground complex number, a MRDR number, a dedicated Wi-Fi node number, etc. For example, an IP address of 1.1.1.1 can be assigned for mine number one, MRDR number 1, dedicated Wi-Fi node number 1, and a randomly assigned or network assigned number, such as 1, in this example. In another example, an IP address of 10.100.1.2 can be assigned for mine number 10, MRDR number 100, dedicated Wi-Fi node number 1 and a randomly assigned or network assigned number, such as 2, for this example.

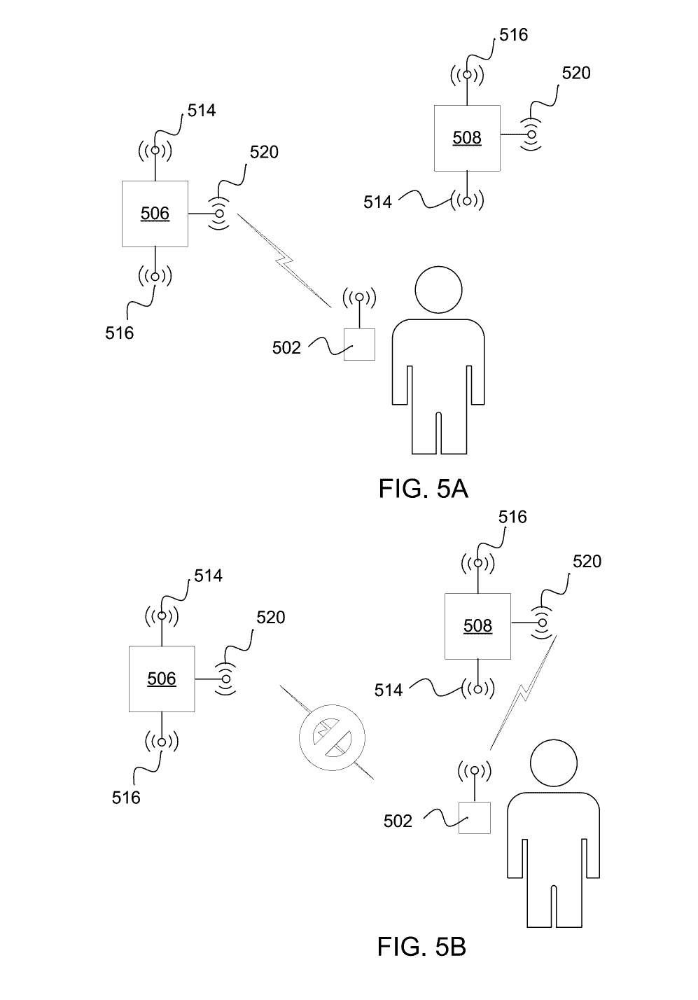

FIG. 5A illustrates an exemplary connection protocol between a user device and a MRDR 506. A user device 502 can communicate with a MRDR 506 via the dedicated WLAN Wi-Fi node 520 using the unique IP address, assigned to the dedicated WLAN Wi-Fi node 520, when a communication signal level between the MRDR and the user device is above a predetermined initial MRDR threshold. An example of such a predetermined initial MRDR threshold is approximately −65 dBm. Alternatively, data can be routed to a MRDR having a highest communication signal level with the user device. The dedicated WLAN Wi-Fi node can be configured to both transmit and receive with a plurality of user devices. In this example, Data that is designated for the user device can be received at the MRDR 506 and can be routed from the dedicated in-by transceiver Wi-Fi node 514 of the MRDR 506 to the dedicated WLAN Wi-Fi node 520 of the MRDR 506. The user device 502 can receive data that is transmitted from the dedicated WLAN Wi-Fi node 520 of the MRDR 506.

The user device 502 can transmit data to be received at the dedicated WLAN Wi-Fi node 520 of the MRDR 506. The data can be routed from the dedicated WLAN Wi-Fi node 520 of the MRDR 506 to the dedicated out-by transceiver Wi-Fi node 516 of the MRDR 506 and routed to another user device, an adjacent or non-adjacent MRDR, a local area network, a wide area network, an internet connection, or another desired location. The

FIG. 5B illustrates an exemplary connection handoff protocol between a user device and multiple MRDRs. Since each dedicated WLAN Wi-Fi node 520 has a unique IP address, a handoff procedure can be used to allow a user device to switch between MRDRs as the user device moves about the wireless network. A user device 502 can detect signals from a plurality of dedicated WLAN Wi-Fi nodes located in a plurality of MRDRs. In this example, an adjacent MRDR 508 is shown. The user device 502 can scan for WLAN signals from adjacent MRDRs at a predetermined frequency, such as every five seconds. The user device 502 can release the unique IP address of the dedicated WLAN Wi-Fi node 520 of the MRDR 506 when the communication signal level between the dedicated WLAN Wi-Fi node 520 at MRDR 506 and the user device 502 is below a predetermined MRDR threshold and/or the communication signal level between the dedicated WLAN Wi-Fi node 520 at an adjacent MRDR 508 and the user device 502 is above the predetermined initial MRDR threshold. An example of such a predetermined MRDR threshold is approximately −80 dBm.

In one embodiment, a handoff can occur when a difference (delta) between the signal levels of different MRDRs is greater than a threshold. For example, when the signal from MRDR 508 is 15 dB greater than a signal from MRDR 506, then a handover may occur. In another embodiment, handoff will occur when a currently received signal is less than a threshold, such as −65 dBm, and another received signal from a dedicated WLAN Wi-Fi node 520 is greater than 15 dB higher than the currently received dedicated WLAN Wi-Fi node 520 signal. The handoff threshold levels are not intended to be limiting. The actual threshold levels are dependent on system design, system performance, user device design and performance, and environmental operating conditions.

When the communication signal level between the MRDR 506 and the user device 502 is below a predetermined MRDR threshold and the communication signal level between the adjacent MRDR 508 and the user device 502 is above the predetermined initial MRDR threshold, the user device 502 can close a connection with the dedicated WLAN Wi-Fi node 520 at the MRDR 506 and setup a connection with the dedicated WLAN Wi-Fi node 520 at the adjacent MRDR 508 using the unique IP address assigned to the dedicated WLAN Wi-Fi node 520 of the adjacent MRDR 508.

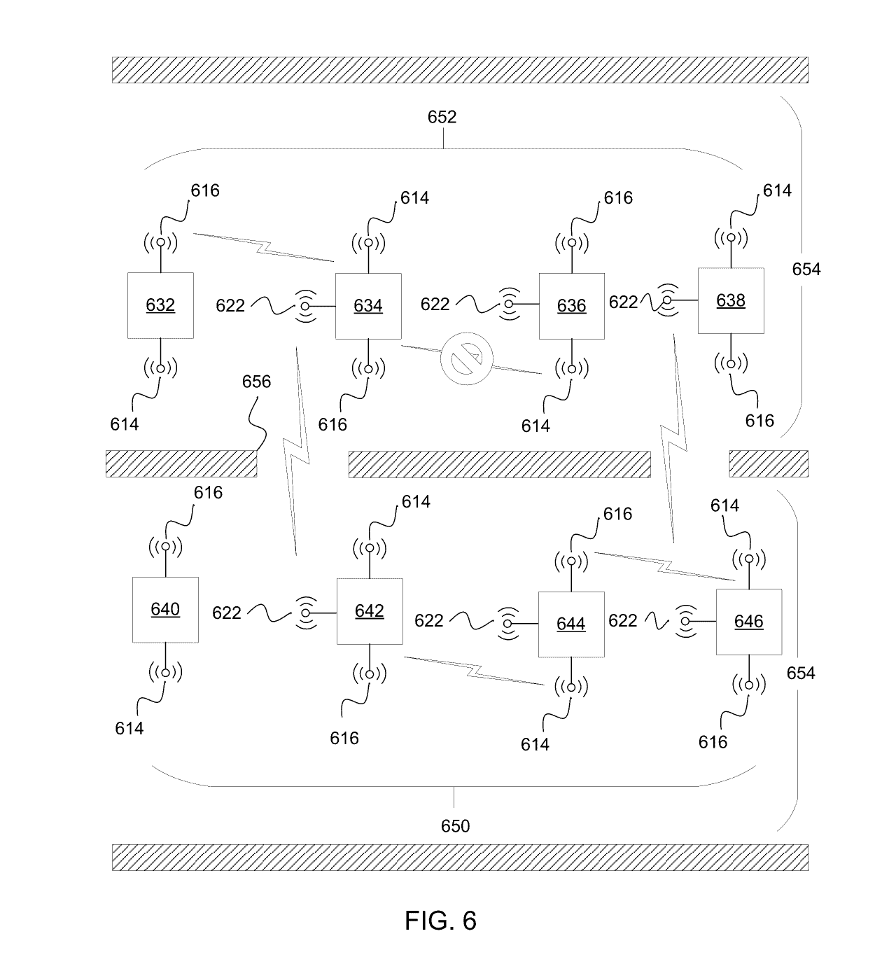

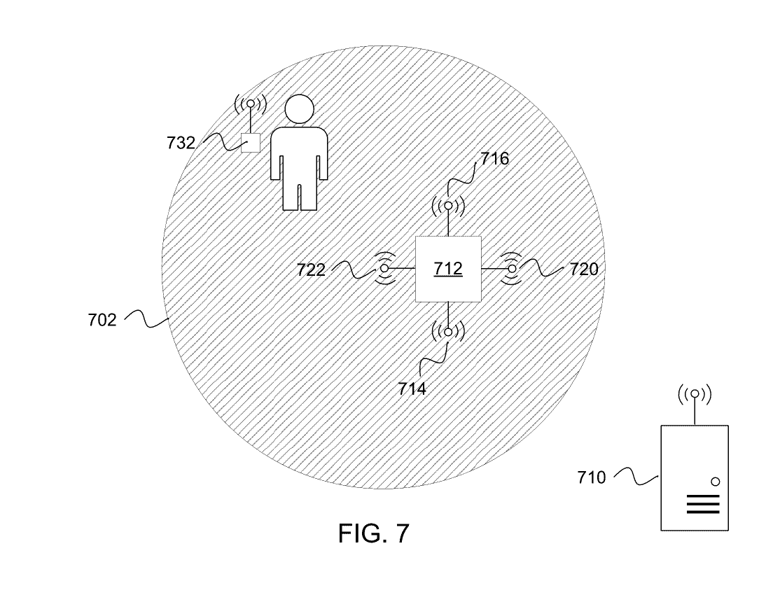

FIG. 6 illustrates data being transferred from one bidirectional array 650 to another bidirectional array 652. Mines and other underground complexes are often formed of shafts 654 and crosscuts 656; shafts 654 can be long, parallel tunnels that extend in one direction and crosscuts 656 can run perpendicular to the shafts 654 and can join two shafts 654 at various intervals for ventilation, safety, or various other reasons. In one configuration, multiple MRDRs are configured along a shaft 654 in a bidirectional MRDR array 650. Additional shafts 654 of a mine or underground complex can be configured with additional bidirectional MRDR arrays 652. Multiple bidirectional MRDR arrays 650, 654 can be blocked from communicating with one another because of possible interference from shaft walls. Therefore, an MRDR 642 of a bidirectional MRDR array 650 can include a dedicated crosscut Wi-Fi node 622 for communication between multiple adjacent bidirectional MRDR arrays.

In one example, data is received by the dedicated in-by transceiver Wi-Fi node 614 of a MRDR 632. A routing module (as shown in FIG. 1) determines that the destination of the data is a destination MRDR 638. A most efficient path is selected between the MRDR 632 and the destination MRDR 638, directing the data to be transmitted to adjacent MRDR 634 on the most efficient path. The data can be routed to the dedicated out-by transceiver Wi-Fi node 616 of MRDR 632 and transmitted to the adjacent MRDR 634. The dedicated in-by transceiver Wi-Fi node 614 of MRDR 634 can receive the data and the routing module can select a most efficient path between the MRDR 634 and MRDR 638. However, the most efficient path may be inaccessible. Therefore, a most efficient path can be selected through an adjacent bidirectional MRDR array 650 between MRDR 624 and MRDR 632, via the dedicated crosscut Wi-Fi node 622. The data can be routed to the dedicated crosscut Wi-Fi node 622 of MRDR 634 and the data can be transmitted to the dedicated crosscut Wi-Fi node 622 of MRDR 642. The data can be received by the dedicated crosscut Wi-Fi node 622 of MRDR 642 and the routing module can select a most efficient path between the MRDR 642 and the destination MRDR 638, directing the data to be transmitted to adjacent MRDR 634 on the most efficient path. The data can be routed to the dedicated out-by transceiver Wi-Fi node 616 of MRDR 642 and transmitted to the adjacent MRDR 644. The dedicated in-by transceiver Wi-Fi node 614 of MRDR 644 can receive the data and the routing module can select a most efficient path between the MRDR 644 and the destination MRDR 638, directing the data to be transmitted to adjacent MRDR 646 on the most efficient path. The data can be routed to the dedicated out-by transceiver Wi-Fi node 616 of MRDR 644 and transmitted to the adjacent MRDR 646. The dedicated in-by transceiver Wi-Fi node 614 of MRDR 646 can receive the data and the routing module can determine that the destination of the data is the adjacent MRDR 638. The data can be routed to the dedicated out-by transceiver Wi-Fi node 616 of MRDR 646 and transmitted to the dedicated in-by transceiver Wi-Fi node 614 of the adjacent destination MRDR 638.

FIG. 7 illustrates tracking a user device 732 based on communication between the user device 732 and a dedicated WLAN Wi-Fi node 720 of a MRDR 712. In one configuration, a dedicated WLAN Wi-Fi node 720 of a MRDR 712 can transmit a location signal at a power level to a user device 732. The location signal can include one or more types of information about the MRDR such as an IP Address, other MRDR identification information, or the location of the MRDR in an underground complex. The power level can be a received signal strength indicator (RSSI) value. In one example, a dedicated WLAN Wi-Fi node 720 of a MRDR 712 can transmit a location signal at a power level to a user device 732. The user device 732 can transmit the location signal to a location server 710 to enable the location server 710 to identify a location perimeter 702 of the dedicated WLAN Wi-Fi node 720 based on a predetermined geographic location associated with the location signal of the dedicated WLAN Wi-Fi node 720. The location perimeter 702 can be the range of the dedicated WLAN Wi-Fi node as defined by a minimum signal strength. An example of the minimum signal strength is −80 dBm. The location perimeter 702 can be a room or enclosure within a mine or underground complex. The predetermined geographic location for each MRDR 712 can be the physical location of the MRDR in the mine or underground complex and can be stored in the location server 710. The location server 710 can determine a location of the user device within the location perimeter 702 based on the power level that the location signal was received by the user device 732. The location server 710 can determine the location of the user device 732 within the location perimeter 702 based on the RSSI of the location signal, as received by the user device 732.

In another example, a dedicated WLAN Wi-Fi node 720 of a MRDR 712 can transmit data at a power level to a user device 732. The user device 732 can identify the unique IP Address of the dedicated WLAN Wi-Fi node. The user device 732 can transmit the unique IP Address of the dedicated WLAN Wi-Fi node 720 to a location server 710 to enable the location server 710 to identify a location perimeter 702 of the dedicated WLAN Wi-Fi node 720 based on a predetermined geographic location associated with the unique IP Address of the dedicated WLAN Wi-Fi node 720 of the MRDR 712. The location server 710 can determine a location of the user device within the location perimeter 702 based on the power level that the data was received by the user device 732. The location server 710 can determine the location of the user device 732 within the location perimeter 702 based on the RSSI of the data, as received by the user device 732.

In another example, a user device 732 can receive multiple location signals from multiple dedicated WLAN Wi-Fi nodes 720. Each location signal can have a power level at which it was received by the user device 732. The power level of each location signal can be an RSSI value. The user device 732 can transmit the multiple location signals of the multiple dedicated WLAN Wi-Fi nodes to a location server 710 to enable the location server 710 to identify multiple location perimeters 702 based on a predetermined geographic location associated with each location signal of the multiple dedicated WLAN Wi-Fi nodes 720 of the MRDR 712. The location server 710 can determine a location of the user device within a common sub perimeter of the multiple location perimeters 702 based on the power levels that the data was received by the user device 732. The common sub perimeter of multiple location perimeters can be the combined area of each location perimeter or an area of overlap among multiple location perimeters.

In another example, a user device 732 can receive signals from multiple dedicated WLAN Wi-Fi nodes 720. Each signal can have a power level at which it was received by the user device 732. The power level of each signal can be an RSSI value. The user device 732 can identify the unique IP Address of each dedicated WLAN Wi-Fi node 720 of the multiple dedicated WLAN Wi-Fi nodes. The user device 732 can transmit the multiple unique IP Addresses of the multiple dedicated WLAN Wi-Fi nodes to a location server 710 to enable the location server 710 to identify multiple location perimeters 702 based on a predetermined geographic location associated with each unique IP Address of the multiple dedicated WLAN Wi-Fi nodes 720 of the MRDR 712. The location server 710 can determine a location of the user device within the union of the multiple location perimeters 702 based on the power levels that the data was received by the user device 732. The location server 710 can determine a location of the user device within the intersection of the multiple location perimeters 702 based on the power levels at which the signal was received by the user device 732.

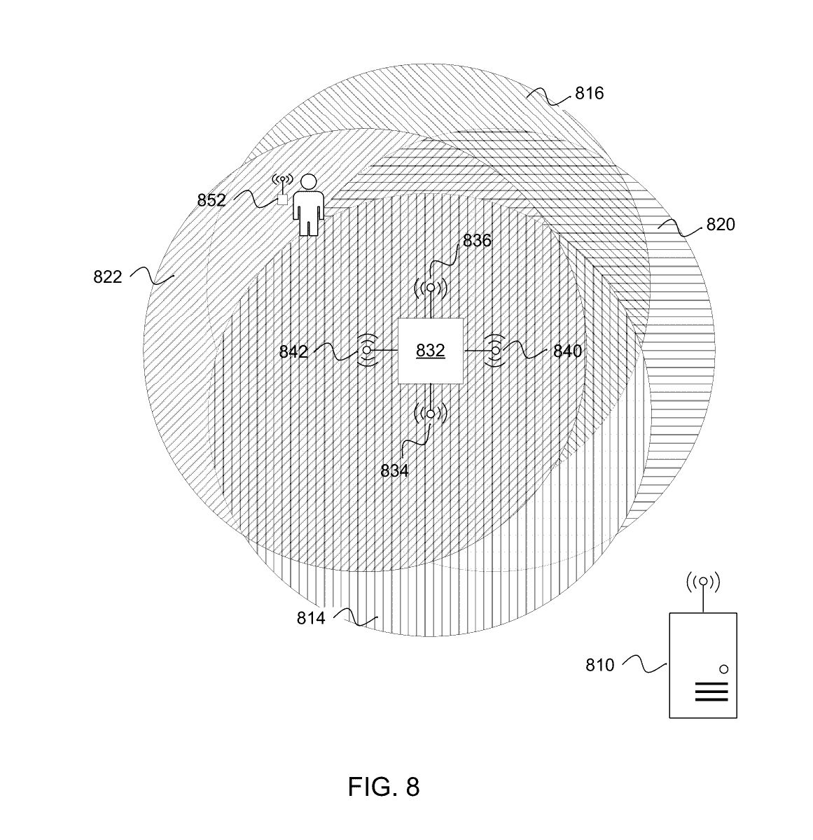

FIG. 8 illustrates tracking a user device 852 based on communication between multiple dedicated Wi-Fi nodes of a MRDR and a user device 852. In one configuration, the dedicated Wi-Fi nodes 834, 836, 840, 842 of a MRDR 832 can receive multiple location signals with multiple power levels from a user device 852. In other words, the dedicated Wi-Fi nodes 834, 836, 840, 842, while dedicated to a single role, can receive signals not within that single role. For example, a dedicated out-by transceiver Wi-Fi node 836, while dedicated to transmitting data, may receive the same signal being received by a dedicated in-by transceiver Wi-Fi node 834 or a dedicated WLAN Wi-Fin node 840. The dedicated Wi-Fi nodes 834, 836, 840, 842 can transmit the multiple power levels of the multiple location signals and the IP Address of each dedicated Wi-Fi node to a location server 810. The location server 810 can identify the location perimeter 814, 816, 820, 822 of each dedicated Wi-Fi node based on the predetermined geographic location associated with the IP Address of each of the plurality of dedicated Wi-Fi nodes. The location server 810 can determine the location of the user device 852 within the common sub perimeter of each of the location perimeters 814, 816, 820, 822 based on the power levels of the location signals as received by each dedicated Wi-Fi node 834, 836, 840, 842. The power levels of the location signals can be the RSSI values of each location signal, as received by each dedicated Wi-Fi node 834, 836, 840, 842.

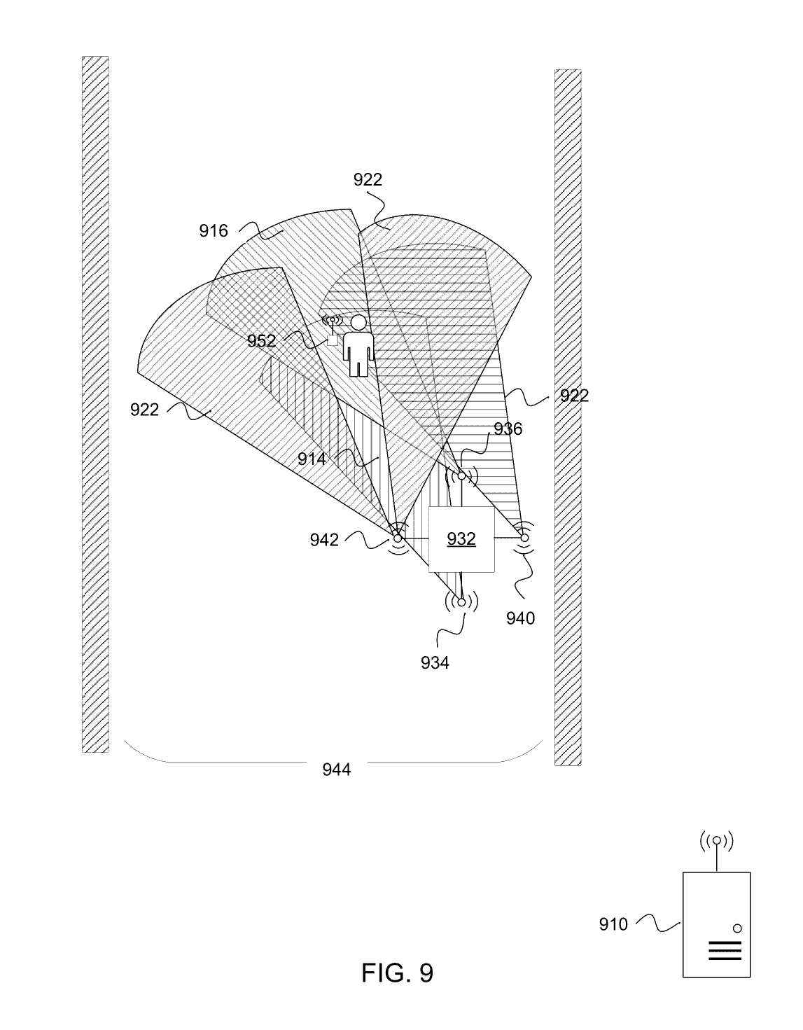

FIG. 9 illustrates tracking a user device 952 based on communication between multiple directional antennas of dedicated Wi-Fi nodes of a MRDR and a user device 952. In one configuration, the dedicated Wi-Fi nodes 934, 936, 940, 942 of a MRDR 932 can have multiple input multiple output (MIMO) directional antennas. A MRDR can use MIMO directional antennas to conserve power for data transmissions or more accurately determine the location of a user device within a prescribed area because mines or underground complexes are often formed in shafts and crosscuts. By directing the MIMO directional antennas in two of the directions of the shaft, the MRDR can use less power to transmit data from adjacent MRDRs or can more accurately track a user device 952 in a smaller prescribed area. In one example, the MIMO directional antennas of the dedicated Wi-Fi nodes 934, 936, 940, 942 of a MRDR 932 can be directed in both directions of the shaft 644 of a mine or underground complex. The MIMO directional antennas of the dedicated Wi-Fi nodes 934, 936, 940, 942 can receive multiple location signals with multiple power levels from a user device 952. The dedicated Wi-Fi nodes 934, 936, 940, 942 can transmit the multiple power levels of the multiple location signals and the IP Address of each dedicated Wi-Fi node to a location server 910. The location server 910 can identify the location perimeter 914, 916, 920, 922 of each dedicated Wi-Fi node based on the predetermined geographic location associated with the IP Address of each of the plurality of dedicated Wi-Fi nodes. The location perimeter 914, 916, 920, 922 of each dedicated Wi-Fi node 934, 936, 940, 942 when using MIMO directional antennas can be smaller portions of the entire range of each dedicated Wi-Fi node 934, 936, 940, 942. The location server 910 can determine the location of the user device 952 within the common sub perimeter of each of the location perimeters 914, 916, 920, 922 based on the power levels of the location signals as received by each dedicated Wi-Fi node 934, 936, 940. The power levels of the location signals can be the RSSI values of each location signal, as received by each dedicated Wi-Fi node 934, 936, 940, 942.

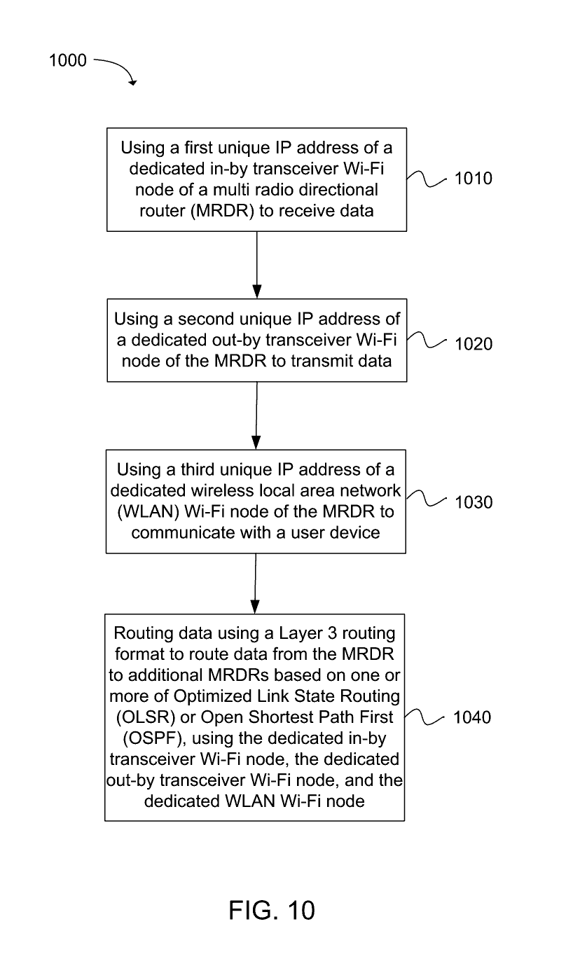

Another example provides at least one machine readable storage medium having instructions 1000 embodied thereon for establishing a connection to a wireless underground communication system, as shown in FIG. 10. The instructions can be executed on a machine, where the instructions are included on at least one computer readable medium or one non-transitory machine readable storage medium. The instructions when executed perform: using a first unique IP address of a dedicated in-by transceiver Wi-Fi node of a multi radio directional router (MRDR) to receive data, as in block 1010. The instructions when executed perform: using a second unique IP address of a dedicated out-by transceiver Wi-Fi node of the MRDR to transmit data, as in block 1020. The instructions when executed perform: using a third unique IP address of a dedicated wireless local area network (WLAN) Wi-Fi node of the MRDR to communicate with a user device, as in block 1030. The instructions when executed perform: routing data using a Layer 3 routing format to route data from the MRDR to additional MRDRs based on one or more of Optimized Link State Routing (OLSR) or Open Shortest Path First (OSPF), using the dedicated in-by transceiver Wi-Fi node, the dedicated out-by transceiver Wi-Fi node, and the dedicated WLAN Wi-Fi node, as in block 1040.

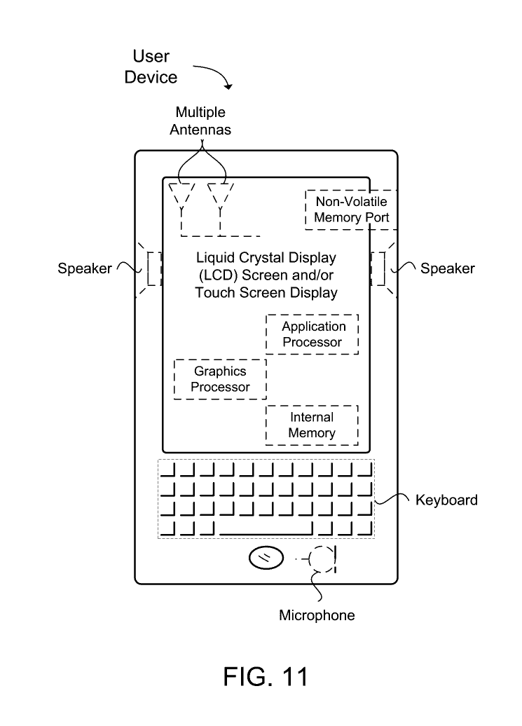

FIG. 11 provides an example illustration of the user device, such as a user equipment (UE), a mobile station (MS), a mobile wireless device, a mobile communication device, a tablet, a handset, a two-way communication device, or other type of wireless device. The user device can include one or more antennas configured to communicate with a dedicated Wi-Fi node or transmission station, such as a base station (BS), an evolved NodeB(eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The user device can be configured to communicate using at least one wireless communication standard including 3GPP LTE, WiMAX, High Speed Packet Access (HSPA), Bluetooth, Ultra High Frequency (UHF), IEEE 802.11a, IEEE 802.11b, IEEE 802.11g, IEEE 802.11n, IEEE 802.11ac, and IEEE 802.11ad. The user device can communicate using separate antennas for each wireless communication standard or shared antennas for multiple wireless communication standards. The user device can communicate in a wireless local area network (WLAN), a wireless personal area network (WPAN), and/or a WWAN.

FIG. 11 also provides an illustration of a microphone and one or more speakers that can be used for audio input and output from the user device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the user device. A keyboard can be integrated with the user device or wirelessly connected to the user device to provide additional user input. A virtual keyboard can also be provided using the touch screen.

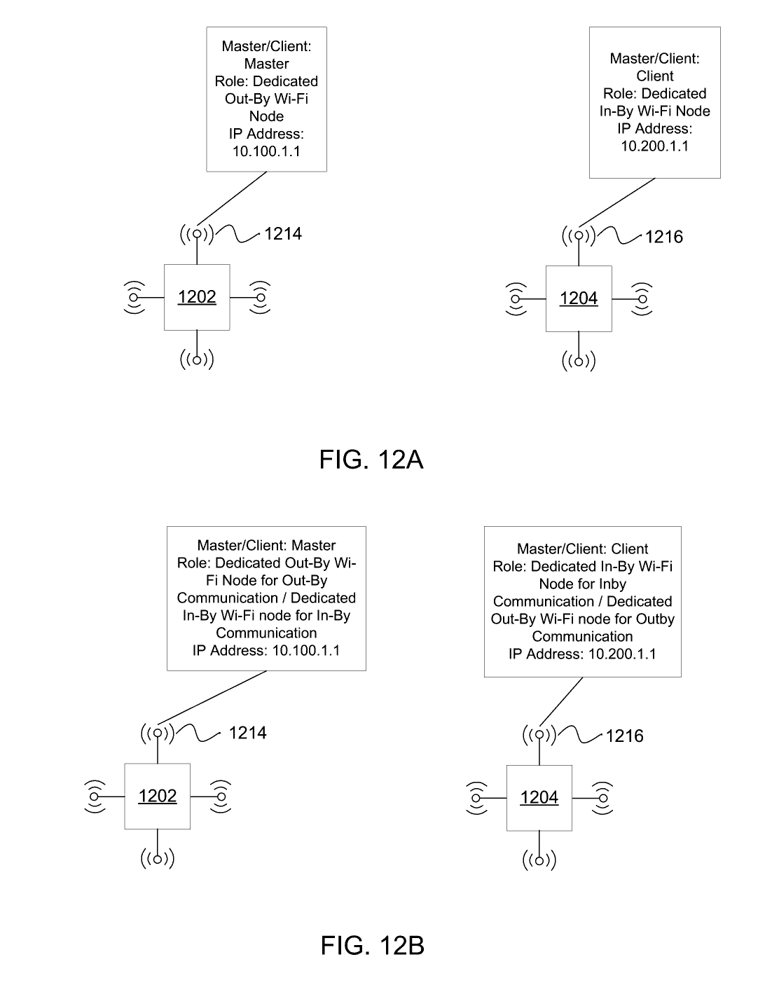

FIG. 12A illustrates an exemplary dedicated role assignment among multiple MRDRs in a master-client relationship. An MRDR 1202 can be configured with a dedicated Wi-Fi node 1214. An adjacent MRDR 1204 can be configured with a dedicated Wi-Fi node 1216. The dedicated Wi-Fi node 1214 can establish a master-client relationship with the dedicated Wi-Fi node 1216 of the adjacent MRDR 1204. In one example, the dedicated Wi-Fi node 1214 of the MRDR 1202 can be configured as the master in the master-client relationship and the dedicated Wi-Fi node 1216 of the adjacent MRDR 1204 can be configured as the client in the master-client relationship. The configuration of the Wi-Fi node 1216 as the master can establish the master node as the access point (AP). In the master-client relationship, the master or dedicated Wi-Fi node 1214 of the MRDR 1202 can be designated as a dedicated out-by transceiver Wi-Fi node for communications between the master and the client. The client or dedicated Wi-Fi node 1216 of the adjacent MRDR 1204 can be a dedicated in-by transceiver Wi-Fi node in communications between the master and the client.

FIG. 12B illustrates an exemplary role assignment for specific communication transmission and reception among multiple MRDRs in a master-client relationship. In one example, the dedicated Wi-Fi node 1214 of the MRDR 1202 can be the master in the master-client relationship and the dedicated Wi-Fi node 1216 of the adjacent MRDR 1204 can be the client in the master-client relationship. In the master-client relationship, the master or dedicated out-by Wi-Fi node 1214 of the MRDR 1202 can be a dedicated out-by transceiver Wi-Fi node for out-by communications and an in-by transceiver receiver Wi-Fi node for in-by communications between the master and the client. The client or dedicated in-by Wi-Fi node 1216 of the adjacent MRDR 1204 can be an in-by transceiver receiver Wi-Fi node for out-by communications and a dedicated out-by transceiver Wi-Fi node for in-by communications between the master and the client.

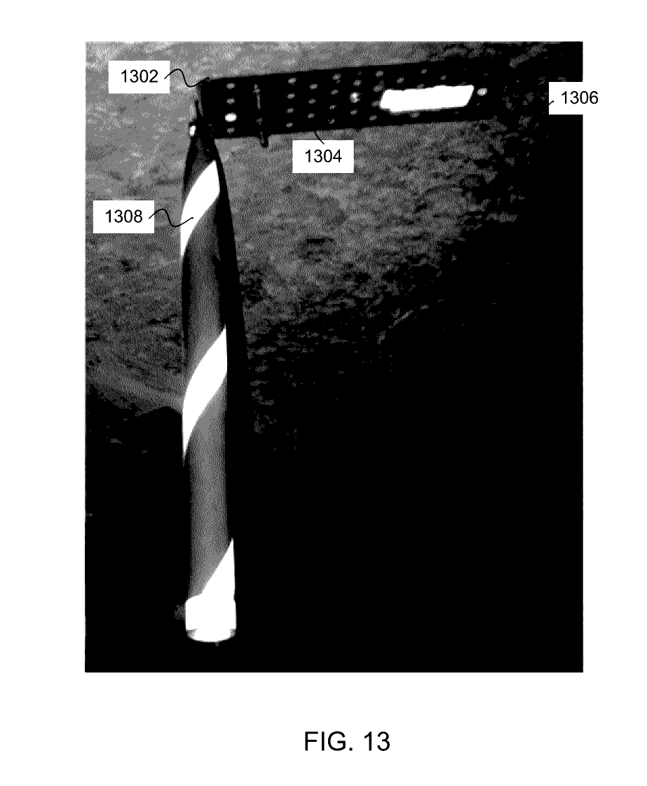

FIG. 13 illustrates a MRDR mounting bracket. The MRDR mounting bracket 1302 can be configured to couple to a mine or underground complex roof, wall, or rib. The MRDR mounting bracket 1302 can include a flat rectangular plate 1304 measuring approximately 4 inches by 14 inches. The flat rectangular plate can be made from approximately ⅛th inch galvanized steel, or another metallic or composite material, with ½ inch holes drilled on a pattern of approximately 1¾ inch centers. At one end, the flat rectangular plate can be formed into a pair of hangers 1306. The formed flat rectangular plate can resemble a half hinge, bent upward such that slots in the tabs of the MRDR fit onto the hangers 1306. The MRDR mounting bracket 1302 can also include a node mounting pole 1308 coupled to the flat rectangular plate 1304. In one configuration, the dedicated Wi-Fi nodes of the MRDR can be positioned on the node mounting pole 1308. The node mounting pole 1308 can be painted in various colors or patterns to identify the type or location of the MRDR. In one example, the node mounting pole 1308 can be painted orange.

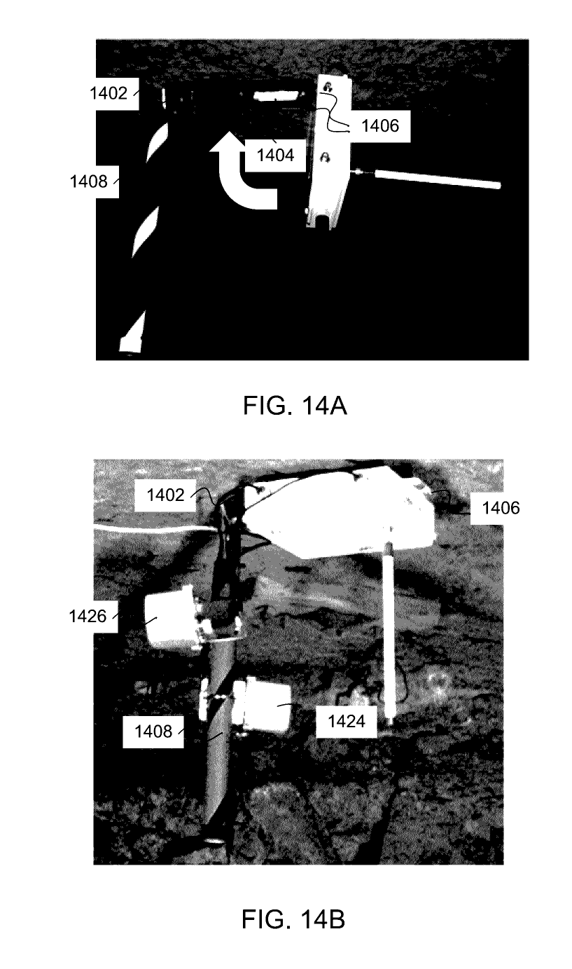

FIG. 14A illustrates one example, when the MRDR mounting bracket 1402 is attached to the back (roof) or rib, the MRDR can be suspended on the hanger by sliding the tab holes over the pair of hangers relieving an installer from holding the weight of the MRDR. The MRDR mounting bracket 1402 can also include a node mounting pole 1408 coupled to the flat rectangular plate 1404. At one end, the flat rectangular plate can be formed into a pair of hangers 1406. An installer can swing the MRDR into a final position, as shown in FIG. 14B, with one hand and secure the MRDRB via a U-bolt attached to the other end of the bracket.

FIG. 14B illustrates a MRDR coupled to a MRDR mounting bracket 1402 in a final position. In one example, the dedicated Wi-Fi nodes 1424, 1426 of the MRDR can be positioned on the node mounting pole 1408.

### Wireless Underground Communication System Power Supply/Battery Backup

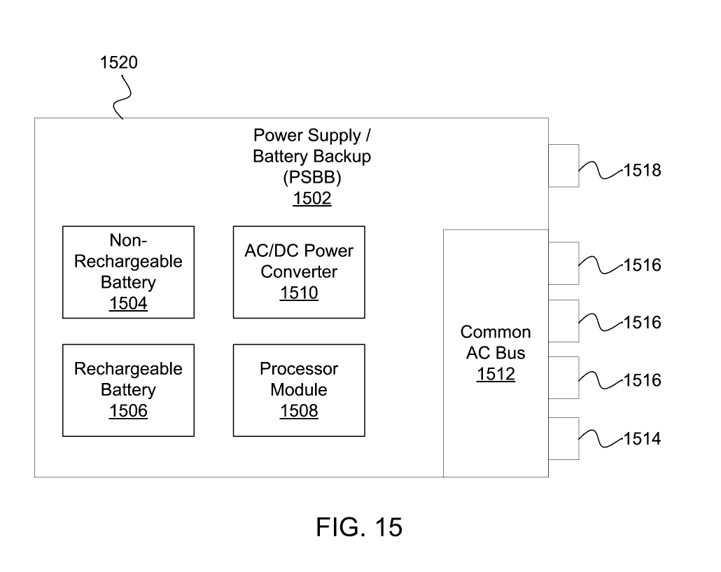

FIG. 15 illustrates a power supply/battery backup (PSBB) that can be configured to power the MRDR. In another embodiment, the MRDR 112 can be configured with a power supply with battery backup. In one example, the MRDR 112 with a PSBB 1502 can be located in a non-gassy mine. The PSBB 1502 can provide the MRDR with a direct current voltage (VDC) in the range of 12 VDC to 48 VDC. The MRDR with a PSBB 1502 can be coupled to mine utility power feed. The mine utility power feed can provide an alternating current voltage (VAC) in the range of 120 VAC to 240 VAC to the PSBB. The PSBB 1502 can provide the MRDR with approximately 2,000 watt hours of battery backup. The PSBB 1502 can include a rechargeable battery 1506 and a non-rechargeable battery 1504. The rechargeable battery 1506 can provide approximately 1,000 watt hours of battery backup. The non-rechargeable battery 1504 can provide approximately 1,000 watt hours of battery backup. The PSBB 1502 can include an AC/DC power converter 1510 configured to convert the 120 VAC-240 VAC of the mine utility feed power to a 12 VDC-48 VDC for the DC output 1518 and for charging the rechargeable battery 1506. In one configuration, the PSBB 1502 can have a common AC bus 1512 with a fused AC input 1514 and multiple AC power outputs 1516. In one example, the PSBB 1502 can have three AC power outputs 1516. In another configuration, the PSBB 1502 can act as an AC junction box for connections between multiple PSBBs.

In one configuration, the PSBB 1502 can be coupled to the MRDR with a direct current (DC) power cable. The DC power cable can be approximately 20-2 AWG. The DC power cable can include a unique electrical connector to prevent inadvertent connection to the wring power source. In one example, the unique electrical connector can be an IP67 connector, although other types of connects can be used. The PSBB can have unique AC connectors and DC connectors. The AC connectors can be the same style as the DC connectors but in a different size to prevent inadvertent connections. In one configuration, each PSBB can be connected directly to the mine utility power feed.

In another configuration, the PSBB 1502 can include a processor module 1508 or processor circuitry that is configured to control voltage and current flow during one or more of the following events: charging batteries, switching between a rechargeable and a non-rechargeable battery, and providing DC power to a MRDR. The PSBB processor module 1508 or processor circuitry can also be configured to perform one or more of displaying PSBB status on multiple LEDs, enabling remote monitoring of battery status, enabling remote controlling of battery charging, or enabling remote backup shutdown or startup.

In one example, the PSBB can be housed in an enclosure 1520. The enclosure 1520 can have a volume of approximately 0.5 cubic feet. The enclosure 1520 can be low profile. The enclosure 1520 can be coupled flush to the mine back or mine roof. The enclosure 1520 can be configured to couple to a rib or mine roof with a PSBB mounting bracket.

### Wireless Underground Communication System and MRDR/Power Supply/Battery Backup Mounting Bracket System

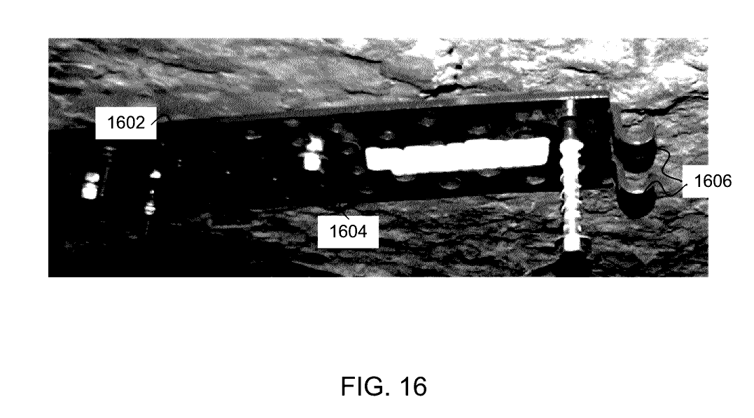

FIG. 16 illustrates an MRDR/PSBB mounting bracket 1602 that can be configured to couple an MRDR/PSBB to a mine back or mine roof. The MRDR/PSBB mounting bracket 1602 can include a flat rectangular plate 1604 measuring approximately 4 inches by 14 inches. The flat rectangular plate 1604 can be made from approximately ⅛th inch galvanized steel with ½ inch holes drilled on a pattern of approximately 1¾ inch centers. At one end, the flat rectangular plate 1604 can be formed into a pair of hangers 1606. The formed flat rectangular plate can resemble a half hinge, bent upward such that slots in the tabs of the MRDR/PSBB enclosures fit onto the hangers 1606. An MRDR/PSBB mounting bracket 1602 can include a lightweight pipe 1308 of approximately 1.5″ diameter attached to the flat rectangular plate 1604 to provide mounting locations for antennas connected to the MRDR with communication cables. In one example, when the MRDR/PSBB mounting bracket 1602 is attached to the back (roof) or rib, the MRDR/PSBB enclosure can be suspended on the hanger 1606 by sliding the tab holes over the pair of hangers 1606 relieving an installer from holding the weight of the MRDR/PSBB. An installer can swing the MRDR/PSBB into a final position with one hand and secure the MRDR/PSBB via a U-bolt attached to the other end of the bracket 1602. The PSBB can be mounted proximate to the MRDR at a distance ranging from approximately 5 feet to 20 feet from the MRDR.

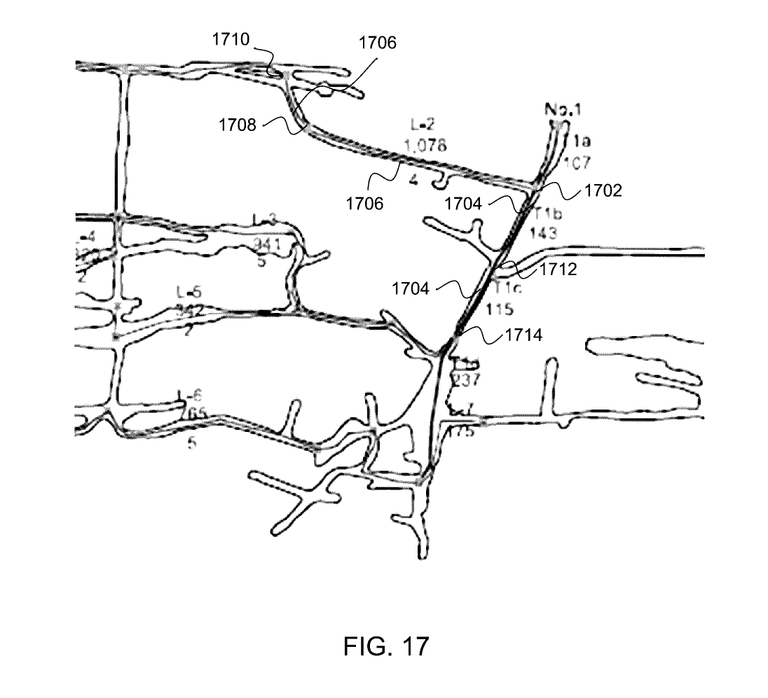

FIG. 17 illustrates multiple PSBBs coupled together with AC feed trunk power lines and lateral power lines. In one example, a first PSBB 1702 can be coupled to a second PSBB 1712 with an AC feed trunk line 1704. In one example, the AC feed trunk line can be approximately 14-3 AWG, although other gauges can be used depending on the current and voltage levels at the power cable.

In another example, the second PSBB 1712 can be coupled to a third PSBB 1714 with an AC feed trunk line. The AC feed trunk line 1704 can be coupled between one of the fused AC power outputs of the second PSBB 1704 and the AC input of the third PSBB 1714.

In another example, the first PSBB 1702 can be coupled to a third PSBB 1708 with a lateral power line 1706. This configuration can be a daisy chain configuration where the lateral power line can be coupled between one of the fused AC power outputs of the first PSBB 1702 and the AC input of the third PSBB 1708. In another example, the third PSBB 1708 can be coupled to a fourth PSBB 1710 with a lateral power line 1706. This configuration can be a daisy chain configuration where the lateral power line can be coupled between one the of fused AC power outputs of the third PSBB 1708 and the AC input of the fourth PSBB 1710.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. The wireless underground communication system, MRDR, routing module, and user device can also include a transceiver module (i.e., transceiver), a counter module (i.e., counter), a processing module (i.e., processor), and/or a clock module (i.e., clock) or timer module (i.e., timer). One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be integrated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A wireless underground communication system comprising:
a multi radio directional router (MRDR) including:
a dedicated in-by transceiver Wi-Fi node, wherein the dedicated in-by transceiver Wi-Fi node is assigned a first unique IP address;
a dedicated out-by transceiver Wi-Fi node, wherein the dedicated out-by transceiver Wi-Fi node is assigned a second unique IP address; and
a routing module configured to route data between a plurality of MRDRs based on one or more of Optimized Link State Routing (OLSR) or Open Shortest Path First (OSPF), using the dedicated in-by transceiver Wi-Fi node and the dedicated out-by transceiver Wi-Fi node.

2. The wireless underground communication system of claim 1, wherein each dedicated in-by transceiver Wi-Fi node of each MRDR of the plurality of MRDRs is assigned a unique IP address and each dedicated out-by transceiver Wi-Fi node of each MRDR of the plurality of MRDRs is assigned a unique IP address.

3. The wireless underground communication system of claim 1, wherein the plurality of MRDRs are configured to operate using a Layer 3 routing format.

4. The wireless underground communication system of claim 1, wherein a dedicated out-by transceiver Wi-Fi node of a first MRDR is configured to communicate data with a dedicated in-by transceiver Wi-Fi node of a second MRDR.

5. The wireless underground communication system of claim 1, wherein:
the MRDR further includes a dedicated wireless local area network (WLAN) Wi-Fi node assigned with a third unique IP address; and
one or more MRDRs from the plurality of MRDRs include a dedicated crosscut transceiver node, wherein a fourth unique IP address is assigned to the dedicated crosscut transceiver node, wherein the dedicated crosscut transceiver node uses the fourth unique IP address to route data between adjacent MRDRs.

6. The wireless underground communication system of claim 5, wherein one or more MRDRs from the plurality of MRDRs include a second crosscut transceiver node, wherein a fifth unique IP address is assigned to the second crosscut transceiver node to route data between adjacent MRDRs.

7. The wireless underground communication system of claim 5, wherein the MRDR is configured to:
communicate with a user device, via the dedicated WLAN Wi-Fi node using the third unique IP address, when a communication signal level between the MRDR and the user device is above a predetermined initial MRDR threshold,
wherein the user device is configured to release the third unique IP address when the communication signal level between the MRDR and the user device is below a predetermined MRDR threshold and a second communication signal level between an adjacent MRDR and the user device is above the predetermined initial MRDR threshold.

8. The wireless underground communication system of claim 5, wherein the MRDR is configured to:
receive a plurality of power levels associated with a plurality of location signals from a user device, via a plurality of dedicated Wi-Fi nodes, wherein the plurality of dedicated Wi-Fi nodes includes one or more of the dedicated in-by transceiver Wi-Fi node, the dedicated out-by transceiver Wi-Fi node, or the dedicated WLAN Wi-Fi node;
transmit the plurality of power levels associated with the plurality of location signals and the IP address of each of the plurality of dedicated Wi-Fi nodes to a location server, to enable the location server to:
identify a location perimeter of each of the plurality of dedicated Wi-Fi nodes based on a predetermined geographic location associated with the IP address of each of the plurality of dedicated Wi-Fi nodes; and
determine a location of the user device within a common sub-perimeter of each of the location perimeters, based on the plurality of power levels of the plurality of location signals.

9. The wireless underground communication system of claim 8, wherein:
each dedicated Wi-Fi node, of the plurality of dedicated Wi-Fi nodes, further comprises a plurality of multiple input multiple output (MIMO) directional antennas; or
each power level, of the plurality of power levels, is a received signal strength indicator (RSSI) value of each location signal, of the plurality of location signals.

10. The wireless underground communication system of claim 1, further comprising:
an additional MRDR that includes at least one dedicated crosscut Wi-Fi node; and
the routing module further configured to route the data between a plurality of bidirectional MRDR arrays, using the at least one dedicated crosscut Wi-Fi node.

11. A wireless underground communication system comprising:
a multi radio directional router (MRDR) including:
a dedicated in-by transceiver Wi-Fi node, wherein the dedicated in-by transceiver Wi-Fi node is assigned a first unique IP address;
a dedicated out-by transceiver Wi-Fi node, wherein the dedicated out-by transceiver Wi-Fi node is assigned a second unique IP address;
a dedicated wireless local area network (WLAN) Wi-Fi node, wherein the dedicated WLAN Wi-Fi node is assigned a third unique IP address; and
a routing module configured to route data between a plurality of MRDRs based on one or more of Optimized Link State Routing (OLSR) or Open Shortest Path First (OSPF), using the dedicated in-by transceiver Wi-Fi node, dedicated out-by transceiver Wi-Fi node, and the dedicated WLAN Wi-Fi node.

12. The wireless underground communication system of claim 11, wherein one or more MRDRs from the plurality of MRDRs include a dedicated crosscut transceiver node, wherein a fourth unique IP address is assigned to the dedicated crosscut transceiver node, wherein the dedicated crosscut transceiver node uses the fourth unique IP address to route data between adjacent MRDRs.

13. The wireless underground communication system of claim 11, wherein each dedicated in-by transceiver Wi-Fi node of each MRDR of a plurality of MRDRs is assigned a unique IP address, each dedicated out-by transceiver Wi-Fi node of each MRDR of a plurality of MRDRs is assigned a unique IP address, and each dedicate WLAN Wi-Fi nodes of each MRDR of plurality of MRDRs is assigned a unique IP address.

14. The wireless underground communication system of claim 11, wherein a plurality of MRDRs are configured to operate using a Layer 3 routing format.

15. The wireless underground communication system of claim 11, wherein the MRDR is further configured to:
communicate with a user device, via the dedicated WLAN Wi-Fi node using the third unique IP address, when a communication signal level between the MRDR and the user device is above a predetermined initial MRDR threshold,
wherein the user device is configured to release the third unique IP address when the communication signal level between the MRDR and the user device is below a predetermined MRDR threshold and a second communication signal level between an adjacent MRDR and the user device is above the predetermined initial MRDR threshold.

16. The wireless underground communication system of claim 11, wherein the MRDR is further configured to:
transmit a location signal at a power level received from the WLAN Wi-Fi dedicated node and the unique IP address of the dedicated WLAN Wi-Fi node, to a location server to enable the location server to:
identify a location perimeter of the WLAN Wi-Fi node based on a predetermined geographic location associated with the unique IP address of the dedicated WLAN Wi-Fi node; and
determine a location of the user device within the location perimeter, based on the power level of the location signal.

17. The wireless underground communication system of claim 11, wherein the MRDR is further configured to:
receive a plurality of power levels associated with a plurality of location signals from a user device, via a plurality of dedicated Wi-Fi nodes, wherein the plurality of dedicated Wi-Fi nodes includes one or more of the dedicated in-by transceiver Wi-Fi node, the dedicated out-by transceiver Wi-Fi node, or the dedicated WLAN Wi-Fi node;
transmit the plurality of power levels associated with the plurality of location signals and the IP address of each of the plurality of dedicated Wi-Fi nodes to a location server, to enable the location server to:
identify a location perimeter of each of the plurality of dedicated Wi-Fi nodes based on a predetermined geographic location associated with the IP address of each of the plurality of dedicated Wi-Fi nodes; and
determine a location of the user device within a common sub-perimeter of each of the location perimeters, based on the plurality of power levels of the plurality of location signals.

18. The wireless underground communication system of claim 11, further comprising:
an additional MRDR that includes at least one dedicated crosscut Wi-Fi node; and
the routing module further configured to route the data between a plurality of bidirectional MRDR arrays, using the at least one dedicated crosscut Wi-Fi node.

19. At least one non-transitory machine readable storage medium having instructions embodied thereon for establishing a connection to a wireless underground communication system, the instructions when executed perform the following:
using a first unique IP address of a dedicated in-by transceiver Wi-Fi node of a multi radio directional router (MRDR) to receive data;
using a second unique IP address of a dedicated out-by transceiver Wi-Fi node of the MRDR to transmit data;
using a third unique IP address of a dedicated wireless local area network (WLAN) Wi-Fi node of the MRDR to communicate with a user device; and
routing data using a Layer 3 routing format to route data from the MRDR to additional MRDRs based on one or more of Optimized Link State Routing (OLSR) or Open Shortest Path First (OSPF), using the dedicated in-by transceiver Wi-Fi node, the dedicated out-by transceiver Wi-Fi node, and the dedicated WLAN Wi-Fi node.

20. The at least one non-transitory machine readable storage medium of claim 19, further comprising instructions when executed perform the following: using a fourth unique IP address at each of one or more dedicated crosscut Wi-Fi nodes to route data between adjacent bidirectional MRDR arrays.

21. The at least one non-transitory machine readable storage medium of claim 19, further comprising instructions when executed perform the following:
receiving a plurality of power levels associated with a plurality of location signals from a user device, via a plurality of dedicated Wi-Fi nodes of a MRDR, wherein the plurality of dedicated Wi-Fi nodes includes one or more of the dedicated in-by transceiver Wi-Fi node, the dedicated out-by transceiver Wi-Fi node, or the dedicated WLAN Wi-Fi node; and
transmitting the plurality of power levels associated with the plurality of location signals and the IP address of each of the plurality of dedicated Wi-Fi nodes to a location server, via a dedicated out-by transceiver Wi-Fi node of a MRDR, to enable the location server to:
identify a location perimeter of each of the plurality of dedicated Wi-Fi nodes based on a predetermined geographic location associated with the IP address of each of the plurality of dedicated Wi-Fi nodes; and
determine a location of the user device within a common sub-perimeter of each of the location perimeters, based on the plurality of power levels of the plurality of location signals.

22. A user device configured to communicate with a wireless underground communication system, the user device comprising:
a transceiver module configured to:
communicate with a multi radio directional router (MRDR) via the dedicated WLAN Wi-Fi node using a unique IP address of the dedicated WLAN Wi-Fi node, when a communication signal level between the MRDR and the user device is above a predetermined initial MRDR threshold;
transmit data to the dedicated WLAN Wi-Fi node of the MRDR, wherein the data is routed from the dedicated WLAN Wi-Fi node of the MRDR to the dedicated out-by transceiver Wi-Fi node of the MRDR; and
receive data from the dedicated WLAN Wi-Fi node of the MRDR, wherein the data is routed from the dedicated in-by transceiver Wi-Fi node of the MRDR to the dedicated WLAN Wi-Fi node of the MRDR; and
a processing module configured to:
release the unique IP address when the communication signal level between the MRDR and the user device is below a predetermined MRDR connection threshold and the communication signal level between an adjacent MRDR and the user device is above a predetermined initial MRDR threshold.

23. The user device of claim 22, wherein the transceiver module is further configured to:
transmit a plurality of location signals at a plurality of power levels to a plurality of dedicated Wi-Fi nodes, wherein the plurality of dedicated Wi-Fi nodes includes one or more of the dedicated in-by transceiver Wi-Fi node, the dedicated out-by transceiver Wi-Fi node, or the dedicated WLAN Wi-Fi node, to enable the MRDR to:
receive a plurality of power levels associated with a plurality of location signals from the user device;
transmit the plurality of power levels associated with the plurality of location signals and the IP address of each of the dedicated Wi-Fi nodes of the plurality of dedicated Wi-Fi nodes to a location server, to enable the location server to:
identify a location perimeter of each of the plurality of dedicated Wi-Fi nodes based on a predetermined geographic location associated with the IP address of each of the plurality of dedicated Wi-Fi nodes; and
determine a location of the user device within a common sub-perimeter of each of the location perimeters, based on the plurality of power levels of the plurality of location signals.

24. The user device of claim 22, wherein the transceiver module is further configured to:
receive a location signal at a power level and a unique IP Address from the dedicated WLAN Wi-Fi node; and
transmit the location signal received from the dedicated WLAN Wi-Fi node and the unique IP address of the WLAN Wi-Fi node, to a location server to enable the location server to:
identify a location perimeter of the WLAN Wi-Fi node based on a predetermined geographic location associated with the IP address of the dedicated WLAN Wi-Fi node; and
determine a location of the user device within the location perimeter, based on the power level of the location signal, as received by the user device.
